(19) United States
(12) Patent Application Publication
(10) Pub. No.: US 2023/0251432 A1
(43) Pub. Date: Aug. 10, 2023

(54) Optical Module

(71) Applicant: Nippon Telegraph and Telephone Corporation, Tokyo (JP)

(72) Inventors: Yuji Fujiwara, Musashino-shi, Tokyo (JP); Ryoichi Kasahara, Musashino-shi, Tokyo (JP); Kei Watanabe, Musashino-shi, Tokyo (JP); Nobutatsu Koshobu, Musashino-shi, Tokyo (JP); Satomi Katayose, Musashino-shi, Tokyo (JP); Katsuhiko Hirabayashi, Musashino-shi, Tokyo (JP)

(21) Appl. No.: 18/004,811

(22) PCT Filed: Jul. 20, 2020
(86) PCT No.: PCT/JP2020/028177

§ 371 Date: Jan. 9, 2023

(51) Int. Cl. G02B 6/36; G02B 6/38

(52) U.S. Cl. CPC G02B 6/3636; G02B 6/3897

(57) ABSTRACT

An optical module includes a planar lightwave circuit optically connected to an optical fiber; a fiber block to which the optical fiber is fixed; and a glass layer that bonds and fixes the fiber block and the planar lightwave circuit. The glass layer is provided in a portion through which light passes between the optical fiber and the planar lightwave circuit in a gap between the connection end face of the fiber block and the connection end face of the planar lightwave circuit. The optical module further includes a thin tube. The thin tube may be provided to penetrate the fiber block. The thin tube can be provided so as to penetrate the planar lightwave circuit or a fixture plate mounted on the planar lightwave circuit.

### TECHNICAL FIELD

The present invention relates to an optical module device, and more particularly to an optical module in which a planar lightwave circuit and an optical fiber are optically connected and which is resistant to high energy light such as visible light used for optical communication and optical sensing, and a method of manufacturing the same.

### BACKGROUND ART

Conventionally, a PLC (planar lightwave circuit) has been used mainly for an optical communication and optical signal processing system. The PLC is actually used in a current communication network, and a splitter for branching light, an optical switch for switching a path of an optical signal, and a laser or a modulator as a light source are realized by the PLC in a broad sense.

The PLC is composed of a quartz-based material, a silicon-based material, a semiconductor-based material, and the like. The PLC is usually not used alone, and in most cases, it is used in the form of an optical module in which the PLC and an optical fiber are connected.

When the PLC is bonded and fixed to an optical fiber in alignment, a fiber block made of glass or the like is used in order to increase the mechanical strength of the bonded portion by widening the bonding cross-sectional area. For example, a V-grooved glass substrate (a V-grooved fiber block), a micro capillary, a ferrule, or the like is used when the PLC and the optical fiber are bonded and fixed. An optical fiber is fixed to such the fiber block, and then the fiber block is adhered and fixed to the PLC. As shown in patent document 1, the PLC and the fiber block to which the optical fiber is fixed are bonded and fixed by filling the gap between the connecting surface of the PLC and the connecting surface of the fiber block with a UV-curable resin adhesive, then aligning the PLC and the optical fiber with a fine alignment device so that the optical coupling ratio between the PLC and the optical fiber is maximized, and then curing the UV-curable resin adhesive is irradiated with an UV-light. Since the UV-curable resin adhesive is cured in about several minutes by irradiation with the UV-light, the curing time is much shorter than that of a room temperature-curable adhesive or a two-pack adhesive which is cured by leaving it for several hours. Thus, the use of the UV-curable resin adhesive and the fiber block results in a good production throughput for adhering the PLC and the optical fiber.

### CITATION LIST

### Patent Literature

[PTL 1] Japanese Patent Application Publication No. 2014-048628

[PTL 2] Japanese Patent Application Publication No. 2018-194802

[PTL 3] Japanese Patent Application Publication No. 2013-1721

### SUMMARY OF INVENTION

In recent years, the PLC devices have been expected to be used as image and sensor devices because the number of steps for alignment is small and vibration is also strong. With the expansion of the adaptation destination of the PLC, the light input to the PLC is also expanded from a communication wavelength band to a visible light band of a shorter wavelength. Therefore, it is necessary to take measures for propagating visible light not only for components constituting an optical module such as the PLC and the optical fiber, but also for an optical connection portion connecting them.

It is known that conventional resin adhesives may deteriorate by absorbing high energy light such as ultraviolet light. In order to suppress an increase in connection loss due to the deterioration of the resin, a connection method is adopted in which only a part where light does not pass is fixed by a resin adhesive in an adhesion part between the PLC and the optical fiber, and a part where light passes is made a gap (air gap). However, as shown in the PTL 2, this connection method has a problem that a dust collection phenomenon occurs in a gap portion through which light passes, and a connection loss increases.

Further, as shown in the PTL 2, a method of filling a portion of the bonded portion through which light passes with quartz glass has been proposed. For example, as one of the simple methods, there is a method of using poly-silazane as a glass precursor. The poly-silazane is a polymer material having a basic unit consisting of [(R1) (R2)Si-N(R3)] R1, R2, R3 = an alkyl group and a vinyl group. The reaction is converted into SiO₂ glass by reacting with water. The SiO₂ glass has a smaller photoreactivity than a resin-based material represented by the UV-curable resin, is hardly deteriorated by input/output light of the optical connection part, and is hardly softened even in a high temperature environment, so that the suppression of the axial deviation of the optical connection part can be expected. However, poly-silazane has a very large curing shrinkage as shown in the PTL 3, and an air gap and a void are generated by curing shrinkage, and it is difficult to fill the optical axis with SiO₂ glass.

One embodiment of the present invention is an optical module in which a planar lightwave circuit having a first waveguide and a second waveguide different from the first waveguide are optically connected via a glass layer, One or more thin tubes for supplying outside air are provided in a region including at least a portion through which light input or output between the first waveguide and the second waveguide passes, of a gap between the connection end face of the first waveguide and the connection end face of the second waveguide, one end of which is located in the region of the gap.

According to one embodiment of the present invention, one or more thin tubes provided in an optical module can supply outside air to an optical connection point and suppress the occurrence of voids in an optical axis in a process of forming a glass layer from a glass precursor. As a result, the glass layer can be efficiently filled in a region including a portion through which the optical axis of the output light passes between the waveguides or the region, and an optical module having resistance to high energy light can be provided with a high yield.

### BRIEF DESCRIPTION OF DRAWINGS

FIG. 1 shows a schematic view of the top surface of an optical module.

FIG. 2 is a perspective and bird’s-eye schematic view of a fiber block in an optical module according to an embodiment of the present invention;

FIG. 3 is a diagram showing a schematic end face of a fiber block in an optical module according to an embodiment of the present invention.

FIG. 4 is a view showing a state of formation of a glass layer at the connection end face of a fiber block in a general optical module.

FIG. 5 is a view showing a state of formation of a glass layer at a connection end face of a fiber block in an optical module according to an embodiment of the present invention.

FIG. 6 is a view schematically showing a connection end face of a fiber block configured using a capillary in an optical module according to a variant of an embodiment of the present invention;

FIG. 7 is a configuration diagram showing a configuration of an optical module according to an embodiment of the present invention.

FIG. 8 shows the measurement results of the loss variation of the optical module.

FIG. 9 is a view schematically showing the connection end face of a planar lightwave circuit in an optical module according to another embodiment of the present invention;

FIG. 10 is a diagram showing a schematic of the connection end face of a planar lightwave circuit in an optical module according to a variant of another embodiment of the present invention;

### DESCRIPTION OF EMBODIMENTS

The embodiments of the invention are described in detail below with reference to the drawings. In the following description, the same or similar reference numerals denote the same or similar elements, and repetitive description may be omitted. Also, the numerical values and material names in the following description are illustrative and not limiting the scope of the present invention, and the present invention comprises: Other numerical values and materials can be used unless they deviate from the gist.

The various embodiments of the invention described below illustrate an optical module in which a waveguide (also referred to as a first waveguide) and a waveguide different from the first waveguide (also referred to as a second waveguide) of the PLC are optically connected via a glass layer. The glass layer is provided in a region including at least a portion through which light input or output between the first waveguide and the second waveguide passes, out of a gap between the connection end face of the first waveguide and the connection end face of the second waveguide. The optical module includes one or more thin tubes, one end of which is located in the region of the gap. The second waveguide is preferably an optical fiber inserted and fixed in the fiber block, that is, the waveguide of the PLC is optically connected to the optical fiber, or the waveguides formed in the two PLCs are optically connected to each other even as a waveguide formed on a PLC different from the PLC formed with the first waveguide. A fixture plate may be mounted on the PLC. The one or more thin tubes may be formed in at least one of components of a fiber block or a PLC or a fixture plate.

### Embodiment 1

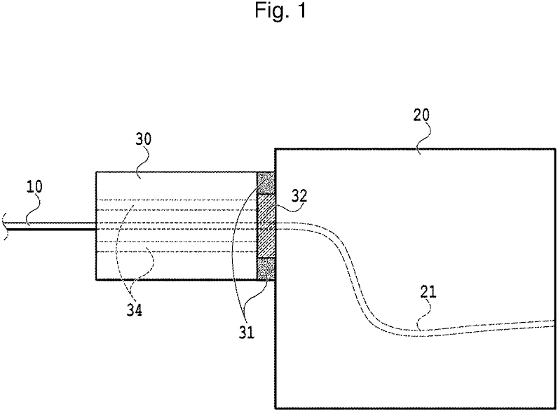

FIG. 1 shows a schematic top view of the optical module of the first embodiment of the invention. This embodiment illustrates an optical module in which a waveguide of a PLC and an optical fiber are optically connected. The optical module shown in FIG. 1 includes an optical fiber 10, a fiber block 30 into which the optical fiber 10 is inserted and fixed, a PLC 20 connected to the optical fiber 10, a UV-curable resin adhesive layer 31 for adhering and fixing a portion where light does not pass between a connection end face of the PLC 20 and a connection end face of the fiber block 30, And a glass layer 32 for adhering and fixing a part through which light passes between the connection end face of the PLC 20 and the connection end face of the fiber block 30.

The PLC 20 includes a waveguide 21 formed on a substrate. The PLC 20 and the fiber block 30 are aligned so that the optical fiber 10 and the waveguide 21 are optically coupled and optically coupled, and the PLC 20 and the fiber block 30 are bonded and fixed.

The fiber block 30 includes two glass substrates 35, for example, a V-groove substrate. The fiber block 30 includes: Two glass substrates 35; an optical fiber 10 inserted and fixed between the two glass substrates 35; and an adhesive layer 36 for bonding the two glass substrates 35 to each other. A V-groove 33 for fixing the optical fiber 10 is formed in one of the two glass substrates 35. Two V-grooves 34 are formed in the other of the two glass substrates 35. The two V-grooves 34 constitute a thin tube. The V-grooves 33 and 34 are formed on opposite surfaces of the two glass substrates 35, respectively.

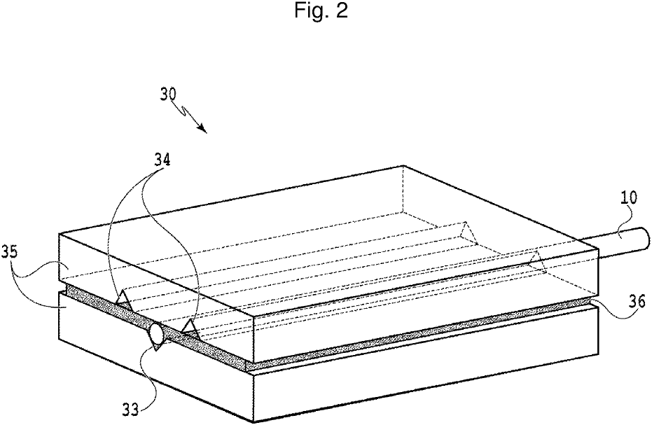

FIG. 2 is a perspective view and a bird’s-eye view outline of the fiber block 30 in the optical module according to the present embodiment. As shown in FIG. 2, the fiber block 30 generally has a structure in which two or more glass substrates 35 are bonded together to sandwich the optical fiber 10 therebetween, or the optical fiber 10 is inserted between the two glass substrates 35 to fix the optical fiber 10, and a V-groove 33 is formed in one of the two glass substrates 35 to fix the optical fiber 10. An optical fiber 10 is fitted into or inserted into the V-groove 33, and fixed by an adhesive to assemble a fiber block 30. In the present embodiment, a V-groove 45 extending from the connection end face to the other end face is formed in the other glass substrate 35 different from the glass substrate 35 on which the V-groove 33 is engraved, so that a thin tube extending in the longitudinal direction of the optical fiber 10 is provided by the V-groove 45 when the fiber block 30 is assembled. The V-shaped grooves 33 may be engraved one by one on each of the two opposing surfaces of the two glass substrates 35, and the optical fiber 10 may be inserted between the two V-shaped grooves 33 and fixed by an adhesive. For example, two V-grooves 34 and one V-groove 33 between the two V-grooves 34 may be engraved in the upper glass substrate 35 in FIG. 2. Alternatively, only one of the two glass substrates 35 may be engraved, for example, on the upper glass substrate 35 in FIG. 2 with two V-grooves 34 and one V-groove 33 between the two V-grooves 34.

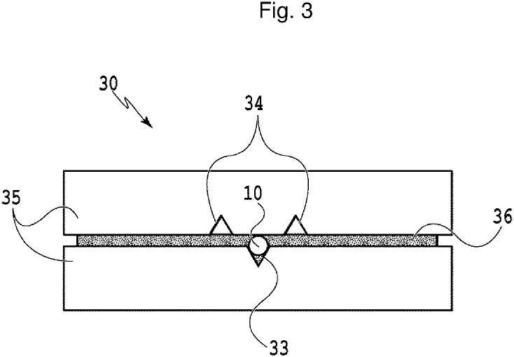

FIG. 3 schematically shows an end face of the fiber block 30 according to the present embodiment. As shown in FIG. 3, in the present embodiment, two of the above-mentioned thin tube (V-grooves 34) are provided, and they are arranged so as to sandwich the optical fiber 10. In the present embodiment, two thin tubes are provided in the fiber block 30, but at least one thin tube may be provided. Further, it is not necessary to arrange the thin tube in parallel with the optical fiber 10. It is preferable that one end of a thin tube provided in the fiber block 30 is on a connection end surface facing the end surface of the fiber block 30, and the other end is on an end surface other than a connection end surface facing the other end surface of the fiber block 30. The V-grooves 34 may be engraved so that the thin tubes are branched and extended to the other ends. By providing the thin tube, when the fiber block 30 and the PLC 20 are connected, outside air can be introduced through the thin tube to a connection point between the fiber block 30 and the PLC 20, that is, a position where the optical fiber 10 and the waveguide 21 face each other or a position where an optical axis passes and a periphery thereof. In the present embodiment, the thin tube penetrating the fiber block 30 is provided by digging the V-groove 34 in the glass substrate 35 constituting the fiber block 30, but the thin tube may be provided in the fiber block 30 by providing a through hole by machining.

The UV-curable resin adhesive layer 31 is provided in a region where light or an optical axis passes and a region other than the periphery thereof, which is provided so as not to extend over the optical axis so as not to cause deterioration by light input/output between the optical fiber 10 and the waveguide 21 of the PLC 20. In this embodiment, the distance between the optical fiber 10 of the optical connection part and the waveguide 21 of the PLC 20 is made constant and the filling amount of the adhesive is controlled, thereby preventing the resin from flowing out to the optical axis. When the area of the end face of the fiber block 30 can be sufficiently secured, a groove for stopping the adhesive may be provided on the end face of the fiber block 30 as shown in the PTL 2.

The glass layer 32 is provided so as to cover an optical axis at a connection point between the optical fiber 10 and the waveguide 21 of the PLC 20, that is, provided at a position where the optical fiber 10 and the waveguide 21 face each other and around it, and the optical fiber 10 and the waveguide 21 of the PLC 20 are optically connected through the glass layer 32. Therefore, it is possible to suppress the dust collection effect as shown in the PTL 2, and to suppress the loss increase with time at the optical connection point. The glass layer 32 is formed by a liquid phase synthesis method. As the liquid phase synthesis method, for example, a sol-gel method in which a liquid raw material is polymerized into a gel state and the gel state is left at room temperature or cured to produce glass, a method in which poly-silazane is left at room temperature or cured to produce glass, or a method in which poly-silazane is cured by hydrolyzing the liquid raw material to produce glass can be used. As one implementation example, poly-silazane can be used as a precursor material of the glass layer 32. The poly-silazane will be briefly described below.

The poly-silazane is an inorganic polymer material having SiH2NH as a basic unit, and is cured by reacting with water to form a high-purity silica film. The silica film after curing is colorless and transparent, has no absorption end to visible light, and has high transparency. Also, since the poly-silazanebecomes inorganic SiO₂ after curing, it has resistance to high energy light and also has heat resistance of about 1000C. Further, since the poly-silazane is a one-liquid type solution, it can be easily filled in a minute gap at a connection point between the optical fiber 10 and the waveguide 21 of the PLC 20. In the present embodiment, poly-silazane is used as the glass precursor, but it is possible to use a material mainly composed of silicon alkoxide Si (OC2H5), a material mainly composed of hydrogen silicofluoride (H2SiF6) and the like. When the optical fiber 10 and the waveguide 21 of the PLC 20 can be fixed so as not to cause optical axis deviation by providing a glass layer 32 having a sufficient area at a connection point, the UV-curable resin adhesive layer 31 need not be provided.

A method of manufacturing the optical module according to the present embodiment will be described below. The PLC 20 can be made, for example, in the following procedure. An under clad layer composed of quartz glass having a thickness of 20 µm and a core layer composed of quartz glass having a thickness of 2 µm, which is increased in refractive index by GE doping, are sequentially deposited on an Si substrate. The core layer is formed into a pattern of the waveguide 21 by a general exposure development technique and etching technique. After that, an overclad layer composed of quartz glass is deposited by 20 µm to form a waveguide 21, the wafer is cut to cut a chip having a size of 5 mm in height by 10 mm in width. The PLC 20 is completed by the above procedure, but a SiO₂ () substrate (a fixture plate 90) having a height of 5 mm X width of 2 mm X thickness of 1 mm is bonded to the end of the PLC 20 chip bonded to the fiber block 30 by the UV-curable resin adhesive in order to enlarge the bonding area with the fiber block 30.

The fiber block 30 can be manufactured, for example, by the following procedure. First, two glass substrates 35 and SiO₂ substrates having a size of 1 mm in thickness and 5 mm in area are prepared. A V-groove 34 for fixing a fiber of φ 125 µ m is formed on one side of the glass substrate 35 by machining, and the optical fiber 10 is fitted into the V-groove 34. The optical fiber 10 is sandwiched by another glass substrate 35, and the two glass substrates 35 and the optical fiber 10 sandwiched by the glass substrates 35 are bonded by the UV-curable resin adhesive to form the UV-curable resin adhesive layer 31, and finally, the end face of the fiber block 30 is polished. The conventional fiber block 30 is completed by the above procedure, but the fiber block 30 in this embodiment forms two V-grooves 34 for introducing outside air on the other glass substrate 35 different from the glass substrate 35 on which the V-grooves 33 used for fixing the optical fiber 10 are engraved before the two glass substrates 35 and SiO₂ substrates are stuck together. In the fiber block 30 of the present embodiment, the two V-grooves 34 are formed symmetrically with respect to the optical fiber 10 when the two glass substrates 35 are stacked and bonded together as described above. In order to prevent the two V-grooves 34 from being filled with the UV-curable resin adhesive, it is necessary to adjust the amount of the adhesive applied to the glass substrates 35 and the pressing pressure at the time of bonding.

The PLC 20 and the fiber block 30 manufactured as described above are fixed to a fine alignment device, and after adjusting the connection position in a state where the connection end face of the PLC 20 and the connection end face of the fiber block 30 are separated by about 1 µm, the PLC 20 and the fiber block 30 are bonded and fixed by using the UV-curable resin adhesive. The adhesion and fixation by the UV-curable resin adhesive are performed in a part where light inputted or outputted between the optical fiber 10 and the waveguide 21 of the PLC 20 does not pass. Therefore, a gap is formed in a part through which light inputted or outputted between the optical fiber 10 and the waveguide 21 of the PLC 20 passes.

After that, after the adhered and fixed PLC 20 and the fiber block 30 are removed from the fine alignment device, poly-silazane as a glass precursor is filled in a gap of a light passing part between the connection end face of the PLC 20 and the connection end face of the fiber block 30, and the poly-silazane is left at room temperature for several days to cure the poly-silazane to form a glass layer 37 in the light passing part. Thus, the optical module of the present embodiment was fabricated.

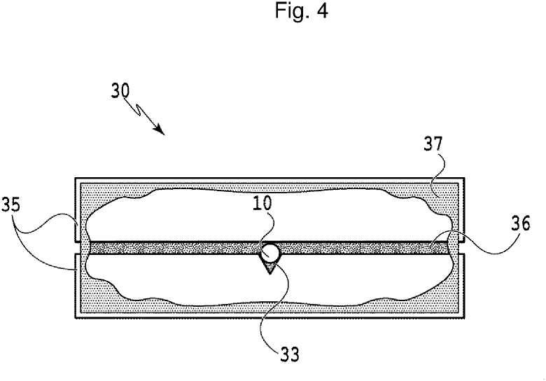

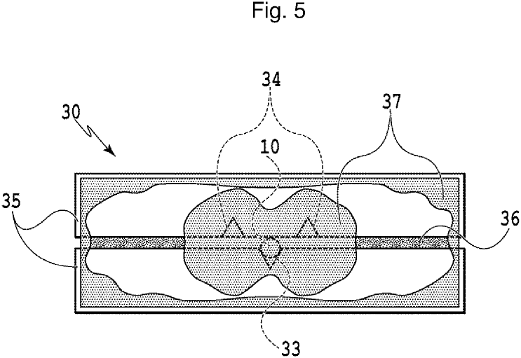

FIG. 4 shows a state of forming the glass layer 37 on the connection end face of the fiber block 30 in a general optical module, and FIG. 5 shows a state of forming the glass layer on the connection end face of the fiber block 30 in an optical module according to an embodiment of the present invention. The glass layer 37 shows a part where poly-silazane is cured and hatched, and the inside of the glass layer 37 shows a part where poly-silazane is not cured and not hatched. FIGS. 4 and 5 show examples in which only poly-silazane is used without using the UV-curable resin adhesive when the PLC 20 and the fiber block 30 are bonded and fixed. In the case of using the UV-curable resin adhesive, the UV-curable resin adhesive layer 31 is formed at a portion where light does not pass, as described above.

As shown in FIG. 4, in a general fiber block 30, since curing of poly-silazane starts from the end of the connection end face of the fiber block 30 to which the outside air is easily supplied, voids are likely to be formed in the central portion of the connection end face of the fiber block 30 and the periphery thereof through which the light passes. This is because the uncured poly-silazane shrinks toward the portion where the curing progresses fast. As a result, the optical connection part of the optical fiber 10 located at the center of the connection end face of the fiber block 30 and the waveguide 21 of the PLC 20 is not filled with the glass layer 37 and the SiO₂ layer and is not formed.

On the other hand, as shown in FIG. 5, in the fiber block 30 of the present embodiment, since the setting of the poly-silazane starts from the position where the end of the thin tube is provided, that is, from the position adjacent to the end of the optical fiber 10 by providing the thin tube V-groove 34 for introducing the outside air, The optical connection part of the optical fiber 10 and the waveguide 21 of the PLC 20 isalso filled with the glass layer 37 and SiO₂. Although the position where the end portion of the thin tube is to be arranged depends on the area of the connection end face of the fiber block 30, it is effective to arrange the end portion of the thin tube within 600 µm from the end portion of the optical fiber 10 in the shape of the fiber block 30 as shown in the present embodiment. In this embodiment, the two V-grooves 34 for introducing the outside air are arranged so as to sandwich the optical fiber 10, but this is so that the glass layer 37 formed by the curing shrinkage of poly-silazane is symmetrical with respect to the optical connection point, and the force applied to the PLC 20 and the fiber block 30 in the curing shrinkage of poly-silazane is made uniform. When the glass layer 37 is asymmetrically formed at the optical connection point, there is a concern that an optical axis deviation occurs in the process of curing and shrinking the poly-silazane, and therefore, in this embodiment, two thin tube V-grooves 34 are provided.

Further, although the fiber block 30 formed by sticking two glass substrates 35 and SiO₂ substrates together is used in this embodiment, a thin tube provided with a plurality of thin tubes may be used instead of the fiber block 30.

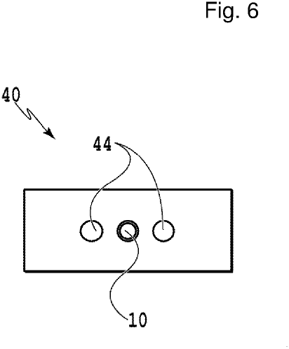

FIG. 6 schematically shows the connection end face of the capillary 40 constituting the fiber block 30 in the optical module according to the modification of the embodiment of the present invention. As shown in FIG. 6, a capillary 40 having three thin tubes 44 is prepared in FIG. 6, and the optical fiber 10 is inserted into one of a plurality of thin tubes 44 in FIG. 6, and one of the remaining thin tubes 44 in FIG. 6 can be used as the thin tubes for introducing the outside air. The thin tubes 44 used for introducing the outside air are preferably positioned on both sides of the thin tube into which the optical fiber 10 is inserted so as to be close to and symmetrical to the optical connection point. Since the optical fiber 10 and the PLC 20 can be bonded with a smaller bonding area than the fiber block 30, when sufficient bonding strength can be secured, it is effective to constitute the fiber block 30 by using the capillary 40.

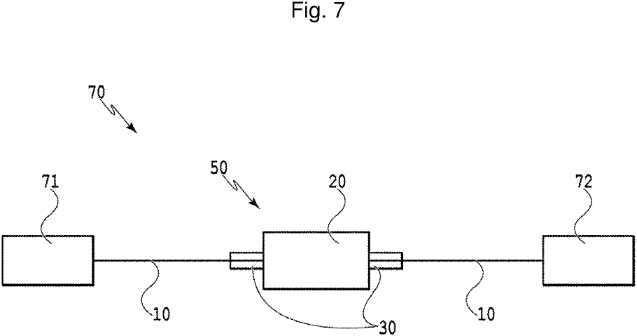

The connection loss was evaluated for the optical module according to the present embodiment manufactured as described above. FIG. 7 shows a measuring system 70 of high power resistance for the optical module according to the present embodiment. As shown in FIG. 7, light having a wavelength of 405 nm is incident from a laser 71 from an input end of an optical module 50 through an optical fiber 10 inserted and fixed in a fiber block 30 connected to the PLC 20, and output power of light emitted from an output end of the optical module 50 is measured by an optical power meter 72.

The insertion loss of the entire optical module is 3.0 dB. Since the transmission loss of the PLC 20 is estimated to be 1.0 dB from the existing measurement, the connection loss at the two input / output ends is considered to be 1.0 dB, respectively.

On the other hand, in the measurement system shown in FIG. 7, the insertion loss of a conventional optical module having a light passing portion as an air gap, that is, without the glass layer 37, is measured instead of the optical module of the present embodiment, As in the measurement result of the present embodiment, the connection loss is about 1.0 dB. Therefore, it was confirmed that even if the light-transmitting portion is filled with poly-silazane, there was no problem in light transmittance, and connection with less loss could be realized.

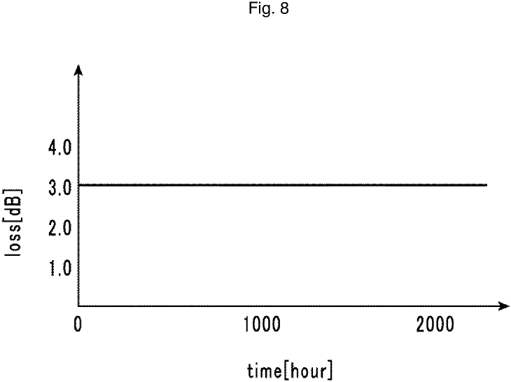

FIG. 8 shows the results when the loss variation of the optical module according to this embodiment is continuously measured for 2000 hours when light having a wavelength of 405 nm and 20 mW is incident. As shown in FIG. 8, it was found that the insertion loss does not change from 3 dB in the optical module according to the present embodiment even after 2000 hours have elapsed.

On the other hand, if the insertion loss of the conventional optical module having the light passing portion as an air gap, I.e., without the glass layer 37 is measured in the same manner, the insertion loss increases in about 100 hours. As described above, it has been confirmed by analysis that dust is collected in the air gap due to the dust collection effect, and the connection loss is increased.

Therefore, it was found from the results shown in FIG. 8 that the optical module according to the present embodiment using poly-silazane also withstands the reliability test. Thus, it is shown that optical connection having resistance to high energy light in a visible region is possible when the optical fiber 10 and the waveguide 21 of the PLC 20 are optically connected by using poly-silazane as in this embodiment.

### Embodiment 2

A second embodiment of the present invention relates to an optical module in which waveguides 21 of two planar lightwave circuits (PLC) 20 are optically connected to each other by using poly-silazane, and a method of manufacturing the optical module.

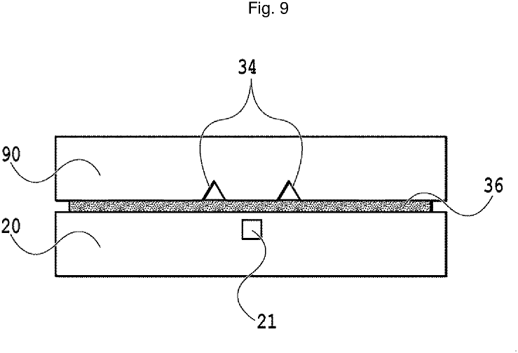

FIG. 9 shows an overview of the connection end face of the PLC 20 in the optical module of this embodiment. As described in the first embodiment, a fixture plate 90 is adhered to each PLC 20. At least one of the two fixture plates 90 facing each other has two V-grooves 34 dug in a surface facing the PLC 20. The V-groove 34 constitutes a thin tube for introducing outside air in a state where the fixture plate 90 is adhered to the PLC 20. One end of the thin tube is on a connection end face of the fixture plate 90, and the other end is on an end face other than the other end face connection end face of the fixture plate 90. The V-grooves 34 may be engraved so that the thin tubes are branched and extended to the other ends. On a connection end face of the fixture plate 90 and the PCL 20, one end of two thin tubes is located close to and symmetrical to a waveguide 21 of the PLC 20. The optical module of the present embodiment can be manufactured by aligning, adhering and fixing two PLCs 20 each having a fixture plate 90 adhered thereto, similarly to the case described in the first embodiment.

When the insertion loss of the optical module according to the present embodiment manufactured in this manner was evaluated, the connection loss at the optical connection point between PLCs was 1.0 dB, The same as the first embodiment applies. In order to evaluate the high power resistance of the optical connection part, the light of 405 nm and 1 mW in wavelength is continuously transmitted through the optical module for 2000 hours, but the insertion loss is only varied. Therefore, the optical module of the present embodiment can also realize an optical connection having high power resistance, as in the first embodiment.

According to the present embodiment, it is possible to realize a compact module in which two PLCs 20 can be directly bonded and fixed without interposing an optical fiber, the optical connection point has resistance to high-power light, and axial deviation hardly occurs even under a high-temperature environment. In addition, compared with the case where two PLCs are connected to each other via an optical fiber, the optical module of the present embodiment reduces the number of optical connection points to half, thereby contributing to improvement in yield and reduction in cost.

In the optical module of the present embodiment described with reference to FIG. 9, the V-shaped groove 34 is formed in the fixture plate to provide the thin tube for introducing the outside air, but as a modified embodiment of the present embodiment, the deep groove may be formed or the thin tube may be formed when the PLC 20 is manufactured.

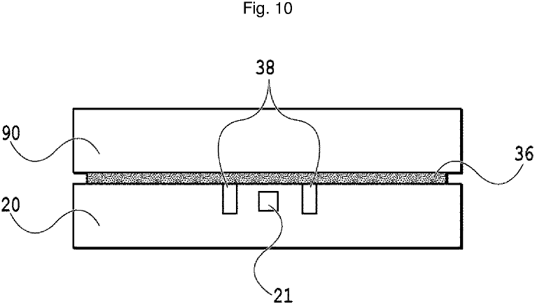

FIG. 10 schematically shows a connection end face of a planar lightwave circuit in an optical module according to a modification of the present embodiment. As shown in FIG. 10, when manufacturing the PLC 20, a deep groove 38 is dug in a surface of the PLC 20 facing the fixture plate 90, and in a state where the fixture plate 90 is adhered to the PLC 20, A thin tube for introducing outside air may be constituted. When there is a process for digging a groove by dry etching or the like at the time of manufacturing the PLC 20, the deep groove 38 for introducing the outside air can be dug at the same time, and the process load can be reduced. In the optical module of FIG. 10, one ends of the two thin tube s are on the connection end face of the PLC 20, and the other ends are on the end face other than the other end face connection end face of the PLC 20. A deep groove 38 may be engraved so that the thin tube is branched and extended to the other ends. On a connection end face of the fixture plate 90 and the PCL 20, one end of two thin tubes is located close to and symmetrical to a waveguide 21 of the PLC 20. The optical module of FIG. 10 can also be manufactured by aligning, adhering and fixing two PLCs 20 each having a fixture plate 90 adhered thereto, as described in the first embodiment.

The optical module can also be manufactured by aligning, adhering and fixing the connection end face of the PLC 20 to which the fixture plate 90 described with reference to FIGS. 9 and 10 is adhered and fixed to the connection end face of the fiber block 30 to which the optical fiber 10 described with reference to FIGS. 1, 2, 3, 5 and 6 is inserted and fixed. Alternatively, the connecting end face of the PLC 20 to which the fixture plate 90 described with reference to FIGS. 9 and 10 is bonded and the connecting end face of the fiber block 30 to which the optical fiber 10 not having the general thin tube described with reference to FIG. 4 is inserted and fixed and the optical fiber 10 is aligned and fixed can be manufactured.

As described above, according to the various embodiments of the present invention, the outside air is supplied to the optical connection point by the thin tubes provided in the fiber block, and the generation of voids caused by the curing shrinkage of the poly-silazane on the optical axis is suppressed. As a result, the optical axis can be efficiently filled with SiO₂, and an optical module having high energy light resistance can be provided with a high yield.

1. An optical module, comprising:
a planar lightwave circuit having a first waveguide and a second waveguide different from the first waveguide are optically connected via a glass layer; wherein
the glass layer is provided in a region including at least a portion of a gap between a connection end face of the first waveguide and a connection end face of the second waveguide through which light input or output between the first waveguide and the second waveguide passes; and
the optical module further comprising one or more thin tubes for supplying ambient air, one end of which is located in the region of the gap.

2. The optical module according to claim 1, further comprising a fiber block, wherein
the second waveguide is an optical fiber inserted into and fixed to the fiber block and the one or more thin tubes are provided in the fiber block.

3. The optical module according to claim 2, wherein
the fiber block is configured using a V-groove substrate or a micro-capillary.

4. The optical module according to claim 1, further comprising
a second planar lightwave circuit having a waveguide different from the planar lightwave circuit having the second waveguide, wherein
the second waveguide is a waveguide included in the second waveguide; and
the one or more thin tubes are provided in at least one of the planar lightwave circuit or the second planar lightwave circuit.

5. The optical module according to claim 1, further comprising:
a fixture plate mounted on the planar lightwave circuit, wherein
the one or more thin tubes are provided on the fixture plate.

6. The optical module according to claim 1, wherein
a material of the glass layer is a quartz-based glass material.

7. The optical module according claim 1, wherein
the one end of the thin tube is disposed at a position within 600 µm from the first waveguide or the second waveguide on a connection end surface of the first waveguide and a connection end surface of the second waveguide.

8. The optical module according to claim 2, wherein
a material of the glass layer is a quartz-based glass material.

9. The optical module according to claim 3, wherein
a material of the glass layer is a quartz-based glass material.

10. The optical module according to claim 4, wherein
a material of the glass layer is a quartz-based glass material.

11. The optical module according to claim 5, wherein
a material of the glass layer is a quartz-based glass material.

12. The optical module according claim 2, wherein
the one end of the thin tube is disposed at a position within 600 µm from the first waveguide or the second waveguide on a connection end surface of the first waveguide and a connection end surface of the second waveguide.

13. The optical module according claim 3, wherein
the one end of the thin tube is disposed at a position within 600 µm from the first waveguide or the second waveguide on a connection end surface of the first waveguide and a connection end surface of the second waveguide.

14. The optical module according claim 4, wherein
the one end of the thin tube is disposed at a position within 600 µm from the first waveguide or the second waveguide on a connection end surface of the first waveguide and a connection end surface of the second waveguide.

15. The optical module according claim 5, wherein
the one end of the thin tube is disposed at a position within 600 µm from the first waveguide or the second waveguide on a connection end surface of the first waveguide and a connection end surface of the second waveguide.

16. The optical module according claim 6, wherein
the one end of the thin tube is disposed at a position within 600 µm from the first waveguide or the second waveguide on a connection end surface of the first waveguide and a connection end surface of the second waveguide.
